(19) United States
(12) Patent Application Publication
(10) Pub. No.: US 2014/0262695 A1
(43) Pub. Date: Sep. 18, 2014

(54) HIGH-PERFORMANCE CONVEYOR BELT SYSTEM

(71) Applicant: TAKRAF GmbH, Leipzig (DE)

(72) Inventor: Dieter HOFFMANN, Leipzig (DE)

(73) Assignee: TAKRAF GmbH, Leipzig (DE)

(21) Appl. No.: 14/204,303

(22) Filed: Mar. 11, 2014

(30) Foreign Application Priority Data
Mar. 12, 2013 (DE) 10 2013 204 244.2

(51) Int. Cl. B65G 15/60

(52) U.S. Cl. CPC B65G 15/60
USPC 198/837

(57) ABSTRACT

A conveyor belt system drive has at least one drive at the head drum or head drums. At least one non-driven relieving roller is arranged in a vicinity of each of the driven upper belt middle rollers. A device brings the driven upper belt middle rollers into a position spaced a distance from the belt. The driven upper belt middle rollers can be removed from the belt for maintenance operations or replacement. It is not necessary to stop the conveyor belt system in case of a defect of a driven upper belt middle roller to repair or replace same. The non-driven relieving roller advantageously assumes the support function of the driven upper belt middle roller, when this is located in the position spaced at a distance from the belt. The driving power of the conveyor belt system is dimensioned such that failure a driven upper belt middle roller can be compensated.

### CROSS REFERENCE TO RELATED APPLICATIONS

This application claims the benefit of priority under 35 U.S.C. §119 of German Patent Application DE 10 2013 204 244.2 filed Mar. 12, 2013, the entire contents of which are incorporated herein by reference.

### FIELD OF THE INVENTION

The present invention relates to a conveyor belt system having at least one drive at a head drum or head drums.

### BACKGROUND OF THE INVENTION

Conveyor belt systems with a high conveying capacity of up to 30,000 tons per hour are now almost exclusively driven by means of drums at the head and at the rear. Capacities of up to 20,000 kW are necessary for the drive in case of great lifting heights or very great conveying lengths.

Due to the concentration of the drives at the head and at the rear, very high belt tensions arise which require belt ratings of up to St 10,000 (load at rupture 10,000 kN/m). These strong belts require long drum diameters of up to 2.5 m and drives with high drive torques. This drives costs up and limits lifting heights and conveying distances.

It has therefore already been attempted for a long time to use intermediate drives at the plug-in idler rollers. Obviously, the previously suggested solutions were not simple and reliable enough, because they were not used in large systems. Moreover, the necessary controls and regulations for the drives have not been available for a long time.

The previous patents for conveyor belt systems with roller drives are briefly summarized below:

Patent DE 502509 A from 1930 and patent GB 263456 A from 1931 deal with untroughed conveyor belts, in which a plurality of rollers are driven by means of one drive. This is complicated and can only be used in small conveyors for individually packaged products.

U.S. Pat. No. 2,655,253 from 1953 uses belt drives to drive a plurality of rollers by an electric motor. This is also costly and not reliable.

Patent GB 1108712 A from 1968 uses a plurality of hydraulic motors connected in parallel at the belt rollers, which are supplied by a pumping unit. This principle is also not practical for large systems.

Patent DE 2146218 A, B, C from 1973 describes a conveyor belt system with single driven idler rollers. The drives can be both inserted and integrated into the roller. The arrangement is, in principle, correct. However, the motor capacities in large systems are so high (7.5-45 kW) that economically the relatively large and heavy electric motor can neither be mounted onto the shaft nor integrated into the belt roller economically. Moreover, the heat dissipation in an integrated drive is not guaranteed.

Patent DE 2326452 from 1974 describes an elastic jacket of the idler rollers, which shall be used as length compensation. This characterizes the failure of electronic regulations.

Patent DE 2831004 A1 from 1980 describes a conveyor belt system, in which a plurality of belt rollers are driven by an electric motor by means of toothed belts or hydraulic motors. This is also not practical for high-performance systems.

Patent DE 3338425 C2 from 1985 describes a conveyor belt with a driving unit under the belt, which is driven by means of friction wheels. However, it is not described how this belt is placed about the drums.

Patent EP 0300127 B1 from 1989 describes a drive for a roller conveyor track integrated into the roller. This is also not a practical solution for large conveyor belt systems.

Patent DE 19639087 and patent DE 19639091 C2 from 1998 describe a belt roller with integrated electric motor. Heat dissipation is problematic here.

Patent EP 0878421 A1 from 1998 shows a planetary gear integrated into the roller. This is costly and less reliable in a large number of drives.

Further, intermediate drives, which are arranged as short drive belts with drums under the actual conveyor belt, are known from the publication DE 203 05 351 U1.

This cost is also relatively high.

### SUMMARY OF THE INVENTION

The basic object of the present invention is to introduce a reliable and simple-to-maintain design of the entire drive for long conveyor belt systems, especially with overcoming of great heights.

A conveyor belt system according to the present invention has at least one drive at the head drum or head drums. Moreover, a plurality of driven upper belt middle rollers is provided, whereby at least one non-driven relieving roller is arranged in direct vicinity of each of the driven upper belt middle rollers. Furthermore, a positioning means is provided for bringing the driven upper belt middle rollers into a position spaced at a distance from the belt. As a result, the driven upper belt middle rollers can be removed from the belt for maintenance operations or replacement. It is thus advantageously not necessary to stop the conveyor belt system in case of a defect of a driven upper belt middle roller to repair or replace same. The non-driven relieving roller advantageously assumes the support function of the driven upper belt middle roller, when this is located in the position spaced at a distance from the belt. In any case, such a defective driven upper belt middle roller can be taken out of operation in order to then repair or replace same at the next scheduled stop of the conveyor belt system. The driving power of the entire conveyor belt system is dimensioned here, such that the failure of one or more driven upper belt middle rollers can be compensated without problems. A conveyor belt system with an efficient drive design is thus advantageously created, which offers, moreover, a very high reliability.

Preferably, the non-driven upper belt middle rollers are likewise brought into a position spaced at a distance from the belt. Thus, these can also be stopped during the operation of the conveyor belt system. Furthermore, the driven upper belt middle roller is preferably closer to the belt than the non-driven upper belt middle roller, so that the load for transmitting the driving torques lies on the driven upper belt middle roller.

In a preferred embodiment, the driven or even non-driven upper belt middle roller to be brought at a distance is arranged at a lever, which is fastened via a fulcrum to the frame of the conveyor belt system. The upper belt middle roller to be brought at a distance is moved away from the belt by means of the lever. In this case, the lever can be operated mechanically (e.g., hydraulically) or even manually.

In an alternative embodiment, the frame of the conveyor belt system consists of a lower frame and an upper frame. The driven middle rollers and the side rollers, which are preferably arranged in an offset manner, are secured to the upper frame. The lower frame and upper frame are connected in the area of an upper belt middle roller or a roller station via height-adjustable connecting means (e.g., a threaded rod with nuts or even hydraulic cylinders). For taking out of operation, the upper frame is lowered via the height-adjustable connecting means and thus the belt rollers arranged at the upper frame are brought into a position spaced at a distance from the belt. The upper frame is thus brought into a position spaced at a distance from the belt. The upper frame is thus moved onto the lower frame and the idler rollers are consequently removed from the belt. The adjacent sets of rollers or roller stations then assume the support function of half of the lowered belt rollers each. Depending on the design of the concrete conveyor belt system and the load during operation, two or more adjacent roller stations may possibly also be lowered.

Furthermore, one of the drives at the head drum(s) is preferably a master drive, whose speed is controlled by means of a frequency converter and the speeds of the other drives at the head drums are regulated by means of frequency converters, such that they generate the same torque as the master drive. Thus, wear-increasing torque differences between the head drums can advantageously be avoided.

Furthermore, the speeds of the driven upper belt middle rollers are preferably regulated via frequency converters, such that they generate driving torques proportional to the master drive. The regulation preferably takes place on a portion of the nominal torque of the master drive.

A plurality of drives for the upper belt middle rollers are especially preferably combined into a group, whereby the group is regulated by a frequency converter. This is especially advantageous in horizontal sections of the conveyor belt system. Advantageously, costs for frequency converters can thus be saved. In the range of 7.5 kW to 45 kW nominal capacity, the electric motors still have a relatively soft characteristic curve and thus a good compensation characteristic. A combination of a plurality of motors into groups, which adhere to one frequency converter, is possible and reduces the cost.

A long conveyor belt system needs a few hundred intermediate drives at the upper belt middle rollers.

Furthermore, besides a driven upper belt middle roller, two non-driven side idler rollers, which are preferably offset, are especially preferably arranged on both sides viewed in the direction of the belt. The side idler rollers are arranged obliquely here, such that the two side idler rollers together with the driven upper belt middle roller form a trough for material uptake. Installation space for a motor located on the outside at the shaft or a return stop or a brake is advantageously created due to the offset arrangement of the side idler rollers and upper belt middle rollers. Advantageously, the means for removing the driven upper belt middle roller are also easily accessible due to the offset arrangement.

The length of the driven upper belt middle roller is preferably selected such that between 60% and 80% and preferably approx. 70% of the load capacity lies on this roller and the remaining weight lies on the non-driven side idler rollers. Thus, the driving power can advantageously be readily transmitted.

Furthermore, the driven upper belt middle rollers preferably have the same lagging on their jacket surface as the driving drum(s) and are cost-effectively secured in two pillow blocks. By means of selecting the same material, similar to identical friction values between upper belt middle roller and driving drum and belt are advantageously achieved, as a result of which the conveyor belt runs very uniformly.

Furthermore, an electric motor, preferably without gear shifting, is preferably coupled at one shaft end of the driven upper belt middle roller via a compensating coupling. Advantageously, the drive is thus low-wear with very easy accessibility for a replacement or a repair. The mounting of the motor at the shaft end has considerable advantages over a motor arranged in the roller interior in terms of accessibility and dissipation of the heat generated during operation.

A return stop or a brake is especially preferably coupled at the other end of the shaft of the driven upper belt middle roller. Thus, after stopping the conveyor belt system, a return of same can be prevented in a simple manner. Return stops are used here in conveyor belt systems with overcoming of heights, while brakes are to be used in horizontal systems.

In ramp belts with approx. 15% gradient, it has proven to be advantageous to drive all upper belt middle rollers at the head and at the rear up to a small area.

In long horizontal belts, it is sufficient to drive approx. every sixth upper belt middle roller. In this case, approx. 200 drives are combined into groups and supplied by an electric station.

This requires a simple and reliable structure. Therefore, basically only the upper belt middle roller, on which approx. 70% of the load capacity lies partly due to the selected cross-sectional geometry, is driven. The upper belt middle roller has an enlarged diameter and is provided with a lagging for improving the conveyability. The upper belt middle roller is mounted in two pillow blocks and has two projecting shaft ends. An eight-pole electric motor is connected at one end of the shaft via a compensating coupling. A return stop is connected in vertical belts and a brake is connected in long horizontal belts at the other end of the shaft. Because of the reliability and heat, a gear shifting is omitted in the intermediate drives. The speed is adjusted via frequency converters as described above. The arrangement described is highly reliable, which is absolutely necessary because of the large number.

Due to the use of the intermediate drives, the capacities of the drum drives advantageously remain at a considerably low level. This reduces the maximum belt tensions, permits the use of belts with lower tensile strength and makes cost savings possible. If nothing else, moderate drum diameters and moderate drum drives are thus also made possible.

Due to the use of intermediate drives at the upper belt middle rollers, the conveyor belt system can be designed economically. A conveyor belt may also be designed for a substantially enlarged length or for a substantially enlarged lift.

In vertical belts, conveying heights of over 1,000 m can be achieved with a conveyor belt due to the use of intermediate drives at almost all upper belt middle rollers.

Furthermore, a driven upper belt middle roller is preferably driven by motors coaxially on both sides, whereby the upper belt middle roller forms a shaft unit with the two motors. A brake or return stop is preferably arranged on the outside at the shaft unit.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a schematic diagram of the conveyor belt system according to the present invention,

FIG. 2 is a cross-sectional view through a conveyor belt system according to the present invention,

FIG. 3 is a cross-sectional view through an alternative embodiment of the conveyor belt system according to the present invention,

FIG. 4 is a view of the means for relieving the driven upper belt middle roller; and

FIG. 5 is a side view of a conveyor belt system according to the present invention with an upper frame and a lower frame movable in relation to one another.

### DESCRIPTION OF THE PREFERRED EMBODIMENTS

Referring to the drawings in particular, FIG. 1 shows a schematic diagram of a conveyor belt system 1 according to the present invention.

This conveyor belt system 1 has a nominal conveying capacity of 24,000 tons/hour on a ramp with 15% gradient and a length of 1,600 m with an overcoming of a height of 240 m. A total power of 19,440 kW is necessary for the operation of this conveyor belt system 1.

The conveyor belt system 1 has three driven head drums 2, 3 and 4 with a driving power of 3×1,800 kW, i.e., a total power of the head drum drives of 5,400 kW and a rear drum 5. The remaining power of 14,000 kW is generated by 560 driven upper belt middle rollers 6 with 25 kW each.

The head drum drive 2 is the master drive. The speed of the head drum 2 is preset by means of a frequency converter. The speeds of the other two head drum drives 3 and 4 are regulated, such that their driving torques are identical to the master drive.

The 560 driven upper belt middle rollers 6 are connected in groups to frequency converters. The speeds of the middle rollers 6 are regulated, such that their torques are proportional to the torque of the master drive.

In this design the maximum operating belt tension is advantageously reduced, such that a conveyor belt made of St 2800 material is sufficient. In addition, a diameter of the driven head drums 2, 3, 4 can thus be left at a moderate 1.25 m and thus these can be produced very cost-effectively.

FIG. 2 shows a cross-sectional view through the conveyor belt system 1 in the area of a driven upper belt middle roller 6, which drives a belt 14 lying on it. This upper belt middle roller 6 has a diameter of 265 mm and a length of 1,000 mm. The driven upper belt middle roller 6 is secured in two pillow blocks 9 and has two projecting shaft ends. An electric motor 11, without gear ratio, is connected to the one shaft end via a compensating coupling 10.

A return stop 12 is put on the other shaft end. This separation advantageously simplifies maintenance and permits a fast component replacement if necessary.

Two side idler rollers 3, by means of which, together with the driven upper belt middle roller 6, the troughed belt 14 is supported, are each arranged laterally, viewed in the belt direction. The lengths of the driven upper belt middle roller 6 and of the side idler rollers 13 are designed here, such that up to 70% of the weight force of the conveyor material rests on the driven upper belt middle roller 6 and up to 30% on the two side idler rollers 13. Thus, of the cross-sectional area of the conveyor material, 70% falls on the belt in the load range of the driven upper belt middle roller 6 and 30% falls on the load ranges of the side idler rollers 13. The side idler rollers 13 are arranged here offset in the belt direction and lie opposite one another. Thus, the accessibility of the driven upper belt middle roller 6, of the electric motor 11 and of the return stop 12 can advantageously be guaranteed.

FIG. 3 shows an alternative embodiment of the driven upper belt middle roller 6. This upper belt middle roller 6 is connected on both sides to an electric motor 11, whereby one of the electric motors 11 has a return stop 12 placed on the outside (on the left side in FIG. 3). Since the motor mounts bear the weight of the upper belt middle roller 6, they must have a reinforced design.

FIG. 4 shows a side view of the positioning means for relieving the driven upper belt middle roller 6. For the sake of clarity, the side idler rollers 13 are not shown in FIG. 4. A relieving roller 16, which is not driven, is arranged in the belt direction directly behind the driven upper belt middle roller 6. Via a manually actuated turnbuckle 21, a lever 18 can be actuated via a fulcrum 17. The lever forms a part of the positioning means for bringing the upper belt middle rollers 6 into a position 20 spaced at a distance from the belt 14 without stopping the conveyor belt system 1. The lever moves the driven upper belt middle roller 6 from a contact position into a position 20 spaced at a distance from the belt 14.

A full-scale view of the upper belt middle roller 6 and the electric motor 11 shows that a mounting of the electric motor onto a shaft end or an integration of the motor into the upper belt middle roller 6 does not make sense.

FIG. 5 shows a side view of a conveyor belt system with a lower frame 26 and an upper frame 27 that form a part of the positioning means for bringing the upper belt middle rollers 28 into a position spaced at a distance from the belt without stopping the conveyor belt system 1. At the upper frame 27 there is a roller station having a driven upper belt middle roller 28 and two side idler rollers 29, whereby a side idler roller is hidden in the view. A threaded rod 30, which is in active connection with a nut 31 at the lower frame 26, is arranged at the upper frame 27. The upper frame 27 and lower frame 26 can be moved towards one another by rotating the nut 31, as a result of which the roller station moves away from the belt. Consequently, the roller station is no longer in connection with the belt, as a result of which the conveyor belt system can continue. The defective roller brought at a distance can be replaced from time to time in a simple manner, even with the conveyor belt system running.

While specific embodiments of the invention have been shown and described in detail to illustrate the application of the principles of the invention, it will be understood that the invention may be embodied otherwise without departing from such principles.

What is claimed is:

1. A conveyor belt system comprising:
at least one driven head drum or driven head drums;
a plurality of driven upper belt middle rollers; and
positioning means for bringing the upper belt middle rollers into a position spaced at a distance from the belt without stopping the conveyor belt system.

2. A conveyor belt system in accordance with claim 1, wherein the positioning means for bringing the upper belt middle rollers into a position spaced at a distance from the belt without stopping the conveyor belt system comprises a lever coupled via a fulcrum.

3. A conveyor belt system in accordance with claim 1, wherein the positioning means for bringing the upper belt middle rollers into a position spaced at a distance from the belt without stopping the conveyor belt system comprises an upper frame and a lower frame divided belt frame, wherein the upper frame and lower frame are movable relative to each other

4. A conveyor belt system in accordance with claim 1, further comprising a relieving roller arranged in a direct vicinity of each of the upper belt middle rollers.

5. A conveyor belt system in accordance with claim 1, wherein the at least one driven head drum or driven head drums comprises a plurality of driven head drums wherein one of drive is a master drive with a speed that is controlled by means of a frequency converter and the speeds of the other drives of the plurality of driven head drums are regulated by means of frequency converters, such that they generate the same torque as the master drive.

6. A conveyor belt system in accordance with claim 5, wherein the speeds of the driven upper belt middle rollers are regulated via frequency converters, such that they generate driving torques proportional to the master drive at the head drum.

7. A conveyor belt system in accordance with claim 1, wherein a plurality of drives at the upper belt middle rollers are combined into a group, wherein the speed of the group is regulated by a frequency converter.

8. A conveyor belt system in accordance with claim 1, further comprising two non-driven side idler rollers arranged offset on both sides next to an associated one of the driven upper belt middle rollers.

9. A conveyor belt system in accordance with claim 8, wherein a length of the driven upper belt middle roller is selected to be such that between 55% and 85% of the load capacity lies on the driven upper belt middle roller.

10. A conveyor belt system in accordance with claim 1, wherein the driven upper belt middle roller has a lagging identical to that of a driving drum and is secured in two pillow blocks.

11. A conveyor belt system in accordance with claim 1, further comprising an electric motor without gear shifting coupled at one end of a shaft of the driven upper belt middle roller via a coupling.

12. A conveyor belt system in accordance with claim 11, further comprising a return stop or a brake coupled at another end of the shaft of the driven upper belt middle roller.

13. A conveyor belt system in accordance with claim 1, wherein a driven upper belt middle roller forms a shaft unit with two motors arranged on the outside.
